(19) United States
(12) Patent Application Publication
(10) Pub. No.: US 2024/0037568 A1
(43) Pub. Date: Feb. 1, 2024

(54) GREENHOUSE GAS EMISSIONS MANAGEMENT METHOD

(71) Applicant: Asuene Inc, Tokyo (JP)

(72) Inventors: Kouhei NISHIWADA, Tokyo (JP); Takehiro WATASE, Tokyo (JP)

(21) Appl. No.: 18/360,499

(22) Filed: Jul. 27, 2023

(30) Foreign Application Priority Data
Jul. 27, 2022 (JP) 2022-120046

(51) Int. Cl. G06Q 30/018

(52) U.S. Cl. CPC G06Q 30/018

(57) ABSTRACT

A method of managing greenhouse gas emissions, according to one embodiment of this invention, comprises determining information regarding energy consumption based on information input by a business terminal of a first business; calculating the amount of greenhouse gas emissions based on the information on the amount of energy used; and managing the information on greenhouse gas emissions entered by a business terminal of a second business that is different from the first business as the greenhouse gas emissions of the first business.

### TECHNICAL FIELD

This invention relates to a method for managing greenhouse gas emissions.

### BACKGROUND ART

With regard to the greenhouse gas emissions of businesses associated with the use of fuel and electricity, etc., reporting systems for SCOPE 1 emissions (direct emissions by the company) and SCOPE 2 emissions (indirect emissions by the company) have become widespread, and progress has been made in the calculation and reduction efforts for SCOPE 1 and SCOPE 2 emissions.

Non-Patent Literature 1 recommends calculating SCOPE 3 emissions as emissions other than SCOPE 1 and SCOPE 2, i.e., emissions from the entire supply chain (raw material procurement, manufacturing, distribution, sales, disposal, etc.), including other related businesses, with the aim of further reducing greenhouse gas emissions by businesses.

### PRIOR ART LIST

### Non-Patent Literature

[Non-Patent Literature 1] “Concept of Calculating Supply Chain Emissions,” Ministry of the Environment, November 2017.

### SUMMARY OF THE INVENTION

### Technical Problem

However, although the technology disclosed in Non-Patent Literature 1 discloses the calculation method of greenhouse gas emissions related to SCOPE 3 or the like, it is very time-consuming for each business, especially companies and local governments, to collect and input a huge amount of data for emissions calculation, calculate the amount of emissions, and manage the calculation results. In particular, in the field of GHG emissions management, the introduction of advanced technology has been slow to improve operational efficiency because the number of SCOPEs whose emissions are subject to calculation is expanding, the data used as the basis for emissions calculation varies widely from one SCOPE to another, and the data management methods differ from one business to another.

Therefore, the purpose of this invention is to provide an efficient method of emissions management by reducing work man-hours in the area of GHG emissions management, such as the calculation of GHG emissions by businesses, through the use of advanced technology.

### Technical Solution

A method of managing greenhouse gas emissions, according to one embodiment of this invention, comprises determining information regarding energy consumption based on information input by a business terminal of a first business; calculating the amount of greenhouse gas emissions based on the information on the amount of energy used; and managing the information on greenhouse gas emissions entered by a business terminal of a second business that is different from the first business as the greenhouse gas emissions of the first business.

### Advantageous Effects

The invention provides an efficient method of management of calculation, etc. of greenhouse gas emissions by business operators.

### BRIEF DESCRIPTION OF THE DRAWINGS

FIG. 1 shows Greenhouse gas emissions management system according to the first embodiment of this invention.

FIG. 2 shows a functional block diagram of a management terminal comprising the greenhouse gas emissions management system.

FIG. 3 shows a functional block diagram of a business terminal comprising the greenhouse gas emissions management system.

FIG. 4 shows the details of the business data according to the first embodiment of this invention.

FIG. 5 shows a diagram explaining the details of invoice information according to the first embodiment of this invention.

FIG. 6 shows an example of transaction information according to the first embodiment of this invention.

FIG. 7 shows another example of transaction information according to the first embodiment of this invention.

FIG. 8 shows a flowchart diagram illustrating an example of the calculation process of greenhouse gas emissions according to the first embodiment of this invention.

FIG. 9 shows a flowchart diagram illustrating an example of a process for predicting the cause of a change in greenhouse gas emissions according to the first embodiment of this invention.

FIG. 10 shows a flowchart diagram illustrating an example of a transaction process of greenhouse gas emissions according to the first embodiment of this invention.

FIG. 11 shows another example of business operator data according to the first embodiment of this invention.

FIG. 12 shows yet another example of business operator data according to the first embodiment of this invention.

### DETAILED DESCRIPTION OF THE EMBODIMENTS

The following is a list and description of the contents of this embodiment of the invention. The greenhouse gas emissions management system (hereinafter simply referred to as “the system”) according to this embodiment of the invention consists of the following:

[Item 1]

A method for managing greenhouse gas emissions, comprising:
determining information on energy consumption based on input information by a business terminal of a first business;
calculating the amount of greenhouse gas emissions based on the information on the amount of energy used; and
managing information on greenhouse gas emissions entered by a business terminal of a second business that is different from the first business as the greenhouse gas emissions of the first business.

[Item 2]

The management method according to item 1, wherein the second business is a business in the supply chain of the first business.

[Item 3]

The management method according to item 1, wherein the first business registers the second business as a guest account for managing greenhouse gas emissions.

[Item 4]

The management method according to item 1, wherein the information on greenhouse gas emissions entered by the business terminal of the second business is managed as information on SCOPE 2 or SCOPE 3 emissions of the first business's greenhouse gas emissions.

### Embodiment 1

The following is a description of the system according to this embodiment, with reference to the drawings.

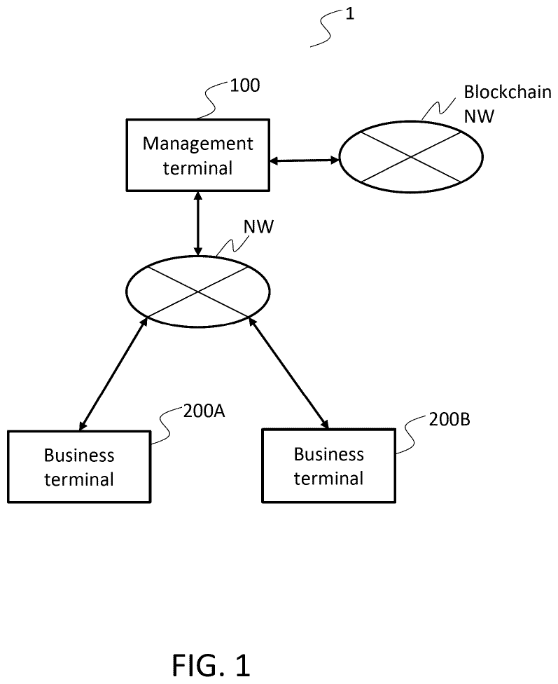

FIG. 1 illustrates a greenhouse gas emissions management system according to the first embodiment of this invention.

As shown in FIG. 1, in this embodiment of the emissions management system 1, a management terminal 100 and multiple business terminals 200A and 200B are connected to each other via a communication network NW.

For example, the management terminal 100 receives from the business terminals 200A and 200B basic information about the business and input information for calculating greenhouse gas (e.g., CO2) emissions (e.g., image data of billing information).

The management terminal 100 analyzes the received image data of the invoice information by machine learning, extracts the necessary items of the invoice information contained in the image data, and calculates the amount of greenhouse gas emissions. The management terminal 100 also analyzes the calculated changes (e.g., increase/decrease) in the amount of greenhouse gas emissions over time using machine learning to predict the cause of the change.

Furthermore, the management terminal 100 has a wallet and connects to a public blockchain network NW. The management terminal 100 generates a single hash value using SHA256 or other hash function based on the above information on greenhouse gas emissions for each predetermined period and records it in the blockchain network as transaction information. On the blockchain network, this block is generated based on the transaction information, the hash value recorded in the preceding block, and the name value mined by the node, and is recorded following the preceding block to form a blockchain. Here, the above-mentioned hash generation and/or recording of transaction information into the blockchain can be performed via other terminals instead of the management terminal 100. In this case, the management terminal 100 transmits the amount of greenhouse gas emissions calculated in the matching process to the other terminals. Furthermore, the management terminal 100 can record the information about greenhouse gas emissions as a smart contract in the blockchain network. By using smart contracts, contracts for emissions trading with other businesses can be automatically generated, approved, and executed without the need for a third party, based on the above information about emissions. In addition, the smart contract enables each business operator to refer to the transaction information without having to go through the management terminal, increasing service convenience and reducing operational costs.

Here, as mentioned above, public blockchains can ensure higher data tamper-resistance and fault-tolerance compared to private blockchains because transactions are approved by an unspecified number of nodes and miners, not by a specific administrator, thus ensuring the security of the transactions. Therefore, it is preferable to use a public blockchain as the destination for recording electricity transactions in this embodiment. Representative public blockchains include Bitcoin, Ethereum, etc. For example, Ethereum has higher non-tampering and reliability among public blockchains.

The management terminal 100 can also associate information on greenhouse gas emissions by identifier or other means and record it in the blockchain network as a Non-Fungible Token (“NFT”). NFTs are, for example, tokens issued under the “ERC721” standard of Etherium, a blockchain network platform, and are units of data that are recorded in the blockchain network and have a non-fungible character. NFTs are recorded on the blockchain together with smart contracts and are traceable, thus providing proof of transaction information, including details and history, such as business information that controls greenhouse gas emissions.

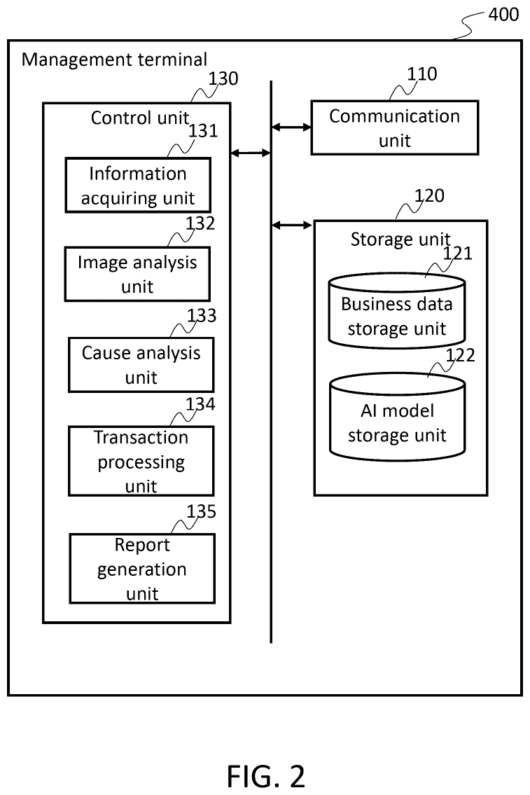

FIG. 2 is a functional block diagram of the management terminal comprising the emissions management system.

Communication unit 110 is a communication interface for communicating with external terminals via the network NW, for example, using communication protocols such as TCP/IP (Transmission Control Protocol/Internet Protocol).

The storage unit 120 stores programs and input data for executing various control processes and functions in the control unit 130, and comprises RAM (Random Access Memory), ROM (Read Only Memory), and the like. The storage unit 120 also has a business data storage unit 121 that stores various data related to businesses, and an AI model storage unit 122 that stores training data and training models learned by AI (artificial intelligence) from the training data. A database (not shown) storing various data may be constructed outside the storage unit 120 or the management terminal 100.

The control unit 130 controls the overall operation of the management terminal 100 by executing a program stored in the storage unit 120, and comprises a CPU (Central Processing Unit), GPU (Graphics Processing Unit), or the like. The functions of the control unit 130 include: an information reception unit 131 that accepts information from external terminals such as the business terminal 200; an image analysis unit 132 that analyzes image data received from the business terminal, such as billing information, and calculates greenhouse gas emissions; a cause analysis unit 133, which analyzes the image data and analyzes the cause of chronological changes in GHG emissions calculated based on the information contained in the extracted invoice information; a transaction processing unit 134, which summarizes the information on greenhouse gas emissions for a predetermined period of time, generates a hash value, and records the hash value as transaction information in the blockchain network; and a report generation unit 135 that generates and transmits report data for outputting the results of the analysis of the cause of the greenhouse gas emissions and changes in emissions to the operator for each predetermined period of time.

Although not shown in the figure, the control unit 130 has an image generation unit to generate screen information to be displayed via the user interface of an external terminal such as the business terminal 200. For example, using image and text data stored in storage unit 120 as materials, the information displayed on the user interface is generated by arranging various images and text in predetermined areas of the user interface based on predetermined layout rules. The processing related to the image generation unit can also be performed by a GPU (Graphics Processing Unit).

The management terminal 100 also has a wallet (not shown) necessary to record transaction information to the blockchain network. This wallet may be external to the management terminal 100.

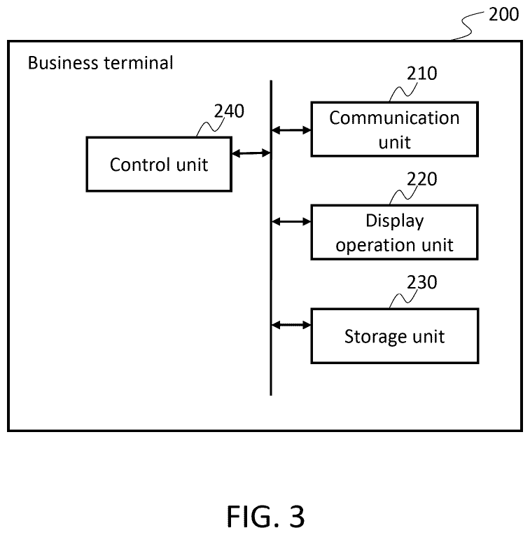

FIG. 3 is a functional block diagram of the business terminal comprising the emissions management system.

The business terminal 200 has a communication unit 210, a display operation unit 220, a storage unit 230, and a control unit 240.

The communication unit 210 is a communication interface for communication with the management terminal 100 via the network NW, for example, using communication protocols such as TCP/IP.

The display operation unit 220 is a user interface used by the business terminal 200 to input instructions and display text, images, etc. in response to input data from the control unit 240, and comprises a display and keyboard or mouse when the business terminal 200 is comprised of a personal computer, and when business terminal 200 is comprised of a smartphone or tablet terminal, it comprises a touch panel, etc. The display operation unit 220 is activated by a control program stored in the storage unit 230 and executed by the business terminal 200, which is a computer (electronic computer).

The storage unit 230 stores programs, input data, and other data for executing various control processes and each function within the control unit 240, and comprises RAM, ROM, and other components. The storage unit 230 also temporarily stores the contents of communication with the management terminal 100.

The control unit 240 controls the overall operation of the business terminal 200 by executing a program stored in the storage unit 230, and comprises a CPU, GPU, or the like.

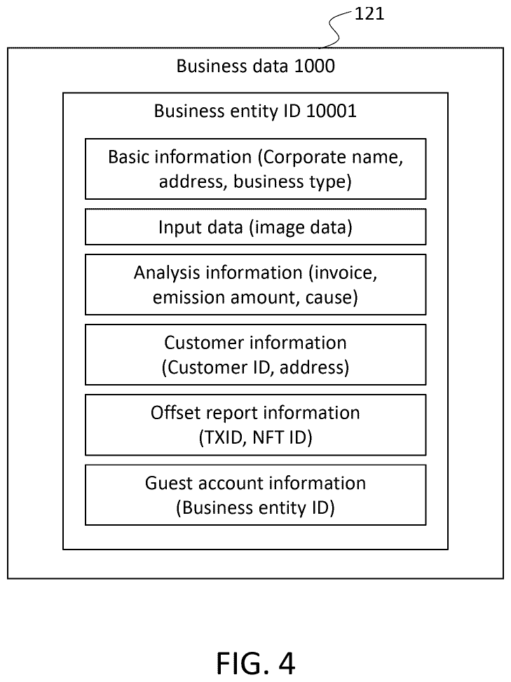

FIG. 4 illustrates the details of the business data according to the first embodiment of this invention.

The business data 1000 shown in FIG. 4 stores various data related to a business operator, obtained from the business operator via the business terminal 200. In FIG. 4, for convenience of explanation, an example of one business entity (the business entity identified by the business entity ID “10001”) is shown, but information on multiple business entities can be stored. Various data related to the business entity include, for example, basic information of the business entity (e.g., the business entity's corporate name, user name, address, business type, contact information, e-mail address, business office name, affiliated company name, and names of related businesses in the supply chain), input information (e.g., image data of invoice information), and analysis information (e.g, information related to invoices extracted from image data, GHG emissions, predicted causes of changes in GHG emissions, etc.), customer information (e.g., customer ID, blockchain address, etc.), and offset report information (e.g., TXID, NFTID, etc.).

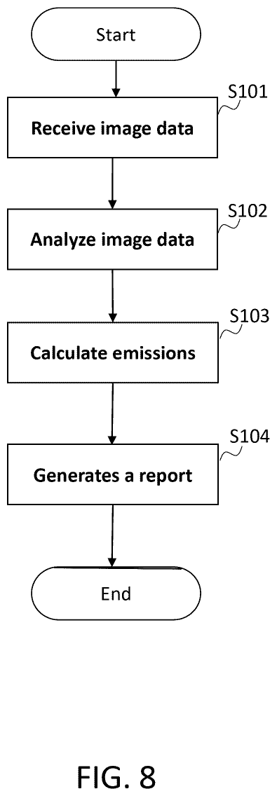

FIG. 8 is a flowchart diagram showing an example of the calculation process of greenhouse gas emissions according to the first embodiment of this invention.

First, as part of the process in step S101, the information acquisition unit 131 of the control unit 130 of the management terminal 100 acquires from the business terminal 200, via the network NW, image data collected by the business, including invoice information. The business uploads invoices, receipts, vouchers, etc. (collectively referred to as “invoices” in this embodiment) in PDF, Excel, JPG, or other file formats (collectively referred to as “image data” in this embodiment) to the management terminal 100 via the business terminal 200. The image data acquired by the information acquisition unit 131 is stored as input information in the business data storage unit 121 of the storage unit 120.

Then, as the process of step S102, the image analysis unit 132 of the control unit 130 of the management terminal 100 analyzes the image data acquired in the previous step using machine learning. The image analysis unit 132 of the control unit 130 of the management terminal 100 uses the so-called OCR method to analyze the image data, and the image analysis unit 132 of the management terminal 100 uses the learning model generated by learning the image data of multiple invoices of various styles stored in the AI model storage unit 122 of the storage unit 120 in advance. Text is recognized from the image data and items included in the invoice information are extracted as structured character string data. For image analysis, an image analysis engine (such as an OCR engine) provided by a business terminal other than the management terminal 100, which may be linked through an API, can be used.

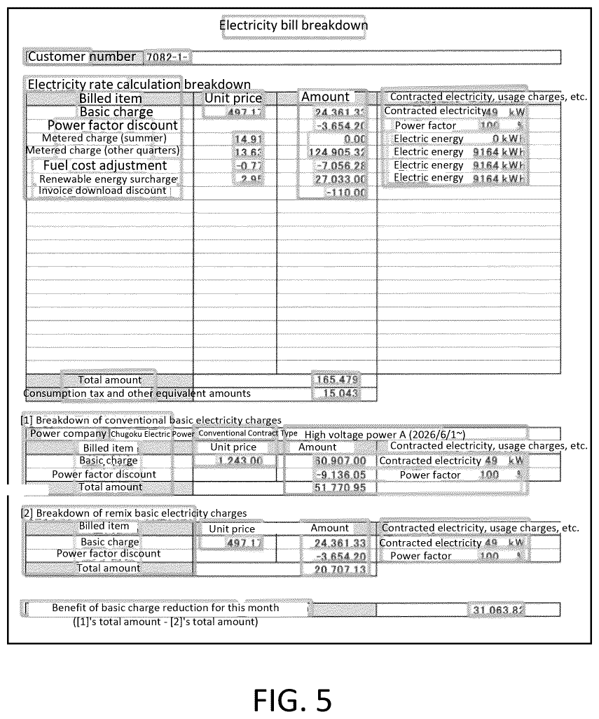

Image analysis is performed, for example, by recognizing and extracting text from image data containing bill information, as shown in FIG. 5.

As shown in FIG. 5, the bill information includes various items included in the bill, such as the name of the electricity bill breakdown, the amount of money for each breakdown (yen), the contracted power (kW), the amount of electricity used for each breakdown (kWh), the total amount of money (yen), and the date (year and month). In this example, the electricity bill breakdown is shown as an example, but it can be a bill for other energy usage including gas and fuel, in addition to electricity, and it can also be, for example, a receipt for travel expenses, a receipt for employer's commuting expenses, a bill for transactions with freight carriers, a bill for transactions with waste disposal operators, etc. The image analysis unit 132 can extract textual information, such as the amount information and the following activity quantity information, from the image data of these invoice information by analyzing the images. The extracted invoice information is stored as analysis information in the business data storage unit 121 of the storage unit 120. Thus, by using machine learning to analyze images, businesses can obtain a vast amount of necessary information for calculating greenhouse gas emissions as image data without having to manually input invoice information, etc., and can accurately extract the information necessary for calculating greenhouse gas emissions through highly accurate image recognition, thereby realizing more efficient and accurate calculation of greenhouse gas emissions.

Next, in step S103, the image analysis unit 132 of the control unit 130 calculates greenhouse gas emissions based on the billing information extracted from the image data. SCOPE1 is the direct emissions of GHGs by the business itself (e.g., emissions from fuel combustion and industrial processes), SCOPE2 is the indirect emissions from the use of electricity, heat, gas, etc. supplied to the business by other companies, and further, SCOPE 3 is a GHG Protocol-issued standard for calculating the emissions of an organization's entire supply chain (the entire flow of raw material procurement, manufacturing, distribution, sales, disposal, etc.). SCOPE 3 further includes 15 categories: 1) purchased products/services, 2) capital goods, 3) fuel and energy-related activities not included in SCOPE 1 and 2, 4) transportation and delivery (upstream), 5) waste from operations, 6) business travel, 7) employee commuting, 8) leased assets (upstream), 9) transportation and delivery (downstream), 10) processing of products sold, 11) use of products sold, 12) disposal of products sold, 13) leased assets (downstream), 14) franchises, and 15) investments. Greenhouse gases include carbon dioxide (CO2), methane (CH4), dinitrogen monoxide (N2O), hydrofluorocarbons (HFCs), perfluorocarbons (PFCs), sulfur hexafluoride (SF6), and nitrogen trifluoride (NF3). CO2 is used as an example in this embodiment.

Furthermore, greenhouse gas emissions are calculated based on the activity quantities defined as the amount of electricity used by a business, the amount of freight transported, the amount of waste disposal, and the amount of various transactions. The activity amounts are then multiplied by CO2 emissions per 1 kWh of electricity used, CO2 emissions per 1 ton of freight transported, and CO2 emissions per 1 ton of waste incinerated as emission intensity. Greenhouse gas emissions are calculated for each of SCOPE 1, SCOPE 2, and SCOPE 3 (15 categories for SCOPE 3), and the total emissions are calculated as supply chain emissions.

In this embodiment, the image analysis unit 132 extracts relevant billing information by SCOPE1, SCOPE2, and SCOPE3 (and further by category for SCOPE3), and calculates emissions based on the above calculation unit based on, for example, kWh of electricity consumption in the billing information. The calculated emissions are stored as analysis information in the business data storage unit 121 of the storage unit 120.

Then, as the process of step S104, the report generation unit 135 of control unit 130 generates a visualized report showing the breakdown of emissions by SCOPE (and further by category for SCOPE 3) in time series, based on the above calculated information on the amount of emissions.

Each business can register a guest account with the management terminal 100 in addition to its own account in order to use the services provided by the management terminal 100 to manage greenhouse gas emissions. Guest accounts can be stored by business ID as business data 1000 in the business data storage unit 121 of the storage unit 120 of the management terminal 100, and can be registered for one or more businesses for a single business. As mentioned above, SCOPE 1 is for direct GHG emissions (e.g., emissions from fuel combustion and industrial processes) by the business itself, SCOPE 2 is for indirect emissions from the use of electricity, heat, gas, etc. supplied to the business by other companies, and SCOPE 3 is for indirect emissions from the use of the organization's supply chain as issued by the GHG Protocol. SCOPE 3 is a standard for calculating the emissions of an organization's entire supply chain (the entire flow of raw material procurement, manufacturing, distribution, sales, disposal, etc.). One business can register a guest account for other businesses in the business's supply chain, together with information on the corresponding SCOPE. Each business entity registered as a guest account can use the guest account to input greenhouse gas emissions for its own direct greenhouse gas emissions (SCOPE 1), using, for example, the methods in S101 through S103 above or other methods.

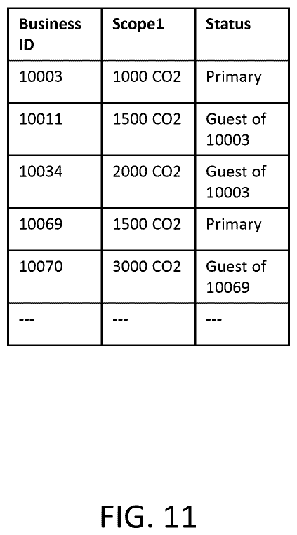

As shown in FIG. 11, the entity corresponding to each entity ID executes the greenhouse gas emissions input process for its own direct greenhouse gas emissions (SCOPE 1). This status information of the account is managed as business data 1000, together with information on whether the business is a primary account user (main user) or a guest account user (guest user to main user) of the service provided by the management terminal 100 for the management of greenhouse gas emissions.

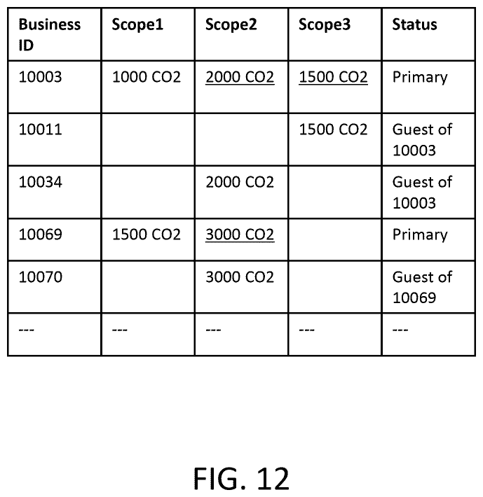

The greenhouse gas emissions information entered by each business is updated with the corresponding SCOPE information as the greenhouse gas emissions information for the account user associated with each user's account, as shown in FIG. 12. For example, as shown in FIGS. 11 and 12, the business with business ID “10011” is a guest account user of the business with business ID “10003”. In the supply chain of the business ID “10003”, when the business with the business ID “10011” is a greenhouse gas emitter of SCOPE 3, the business enters “1500CO2” for the amount of greenhouse gas emissions emitted by itself, as shown in FIG. 11. Then, as shown in FIG. 12, the entered information is automatically reflected as the emissions information of SCOPE 3 for the business with business ID “10011”.

Similarly, the business with business ID “10034” is a guest account user of the business with business ID “10003” and is a SCOPE 2 greenhouse gas emitter in the supply chain of the business with business ID “10003”. As shown in FIG. 11, when the business enters “2000CO2” for the amount of greenhouse gas emissions emitted by itself, the entered information will automatically be reflected as the SCOPE2 emissions information for the business with business ID “10011”, as shown in FIG. 12.

In this way, one business registers a guest account corresponding to another business, and the business in the guest account enters information on its own greenhouse gas emissions. As a result, the business can manage the emissions information of other SCOPEs based on the information entered by the business in the guest account, without the business entering information on GHG emissions other than its own GHG emissions. Or, even if one of the above providers (the primary account business) inputs information on emissions by other businesses (i.e., information on emissions of other SCOPEs other than SCOPE 1), the information can be compared with the information on emissions input by the guest account business operator. Therefore, the accuracy of the information can be ensured.

The guest-account business operator may also switch the account status to register as a primary account. Furthermore, while managing its own GHG emissions information, it can manage emissions information entered by other businesses associated with the primary account it has switched to (guest account businesses from the perspective of the primary account business) as emissions information for other SCOPEs in the same manner as described above.

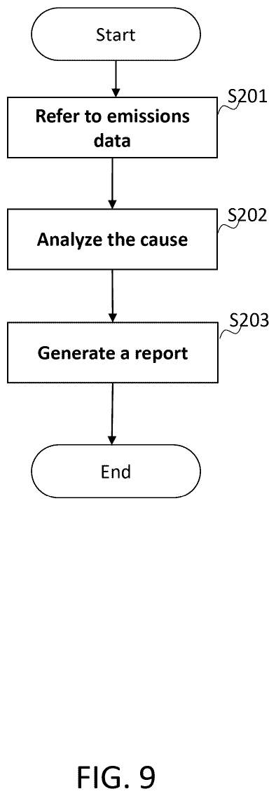

FIG. 9 is a flowchart diagram showing an example of a process for predicting the causes of changes in greenhouse gas emissions according to the first embodiment of this invention.

First, as the process of step S201, the cause analysis unit 133 of the control unit 130 of the management terminal 100 refers to the information on the business terminal's greenhouse gas emissions calculated in step S103 of FIG. 8. Here, the greenhouse gas emissions are referenced by SCOPE (and further by category for SCOPE 3). In addition, the cause analysis unit 133 can check for changes (increase or decrease) in emissions by referring to past emissions data for the same business with respect to the amount of greenhouse gas emissions. As described above, emissions are stored as assessment unit information in the business data storage unit 121 of the storage unit 120.

Then, as the process of step S202, the cause analysis unit 133 analyzes and predicts the cause of the change in emissions by machine learning based on the above referenced information on emissions. In analyzing the cause, the cause analysis unit 133 of the control unit 130 of the management terminal 100 uses the above referenced information on emissions, factors affecting the change (increase/decrease) in emissions, and a learning model generated by learning data on factors affecting emission changes (increase or decrease), stored in the AI model storage unit 122 in the storage unit 120, in advance, to predict the causes of changes in emissions by SCOPE (and further by category for SCOPE 3).

Factors that influence changes in emissions (increase or decrease) include, for example, weather, temperature, product demand and/or factory operations, store or factory opening or operating hours, equipment or facility changes, strategies implemented by software, energy-saving practices, fuel conversion, energy menu changes, variations in business travel or commuting distances and the amount of on-site power generation. Each of these factors can affect the emissions of any of the SCOPEs. For example, the weather factor could affect precipitation, wind speed, sunshine duration, and temperature. Precipitation affects small hydropower generation, wind speed affects wind power generation, sunshine duration affects solar power generation, and temperature affects air conditioning systems. Moreover, power generation has an influence on self-generation amounts, which in turn, affect CO2 emissions from electricity usage. This, in effect, affects the variations in Scope 2 emissions. On the other hand, air conditioning systems can impact gas consumption, which, in turn, affects CO2 emissions from gas combustion. Consequently, this has an effect on the variations in Scope 1 emissions. In addition, power-saving activities, plant operation due to product demand, and operating hours affect electricity consumption, which in turn affects SCOPE 2. In addition, EMS, replacement of refrigeration equipment, installation of energy-saving equipment, and automobile usage also affect electricity usage, which in turn affects SCOPE2, while automobile usage, fuel consumption, boiler usage, and boiler efficiency affect fuel usage, which in turn affects CO2 emissions from fuel, which in turn affects SCOPE′.

Additionally, the following factors impact the corresponding Scope 3 categories: product sales volume affects categories 1, 9, 10, 11, and 12; facility investments influence category 2; renewable energy ratio and energy procurement amounts impact category 3; transportation frequency and changes in transportation routes affect categories 4 and 9; product loss rate influences category 5; business trips and in-office employee numbers impact category 6; commuter numbers and in-office staff numbers affect category 7; power consumption influences category 8; processing reduction due to product improvements impacts category 10; improvements leading to energy-saving products influence category 11; increased recycling rate affects category 12; office electricity consumption in rented spaces corresponds to category 13; franchise emissions are linked to category 14; emissions from investments in various entities impact category 15.

Thus, by learning which factors affect which SCOPE or category by machine learning, and by obtaining information on emissions and each factor from the business, it is possible to predict the cause of changes in emissions. By using machine learning to predict the causes of emissions, it is possible to efficiently and accurately predict the factors that affect changes in GHG emissions for each business and for each SCOPE.

Then, as the process of step S203, the report generation unit 135 of the control unit 130 generates a visualized report on the causes of changes in emissions by SCOPE (and further by category for SCOPE 3), based on the above analyzed information on the predicted causes of changes in emissions.

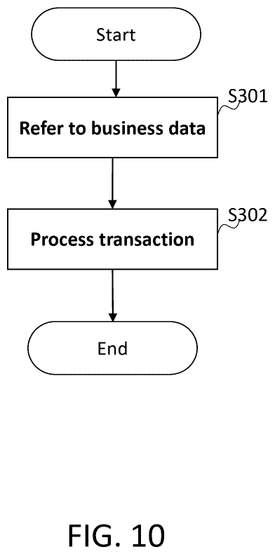

FIG. 10 is a flowchart diagram of an example of a greenhouse gas emissions transaction process according to the first embodiment of this invention.

First, in step S301, the transaction processing unit 134 of the control unit 130 of the management terminal 100 refers to the business data stored in the business data storage unit 121 of the storage unit 120. Here, the business operator data to be referenced includes analysis information (greenhouse gas emissions per SCOPE) and other data of the business operator.

Next, as the procedure in step S302, the transaction processing unit 134 generates a hash value based on the business data referenced in step S301.

In other words, the transaction processing unit 134 generates one line of hash value for greenhouse gas emissions for a given period using a hash function and records the hash value as transaction information in the public blockchain. On the blockchain network, a new block is generated based on the transaction information, the hash value recorded in the preceding block, and the Nance value mined by the node. This new block is then recorded following the preceding block, forming a blockchain. Here, in this example, the block may be recorded in layer 2 (e.g., sidechain), which is different from the main blockchain (so-called layer 1), in order to reduce the costs associated with blockchain recording.

The transaction processing unit 134 can also assign and manage NFTIDs in connection with blockchain records of greenhouse gas emissions of the business. More specifically, as shown in FIG. 4, the business data 1000 can be assigned the customer ID of the business and store the blockchain address to be referenced as customer information, and the NFTID and TXID can be assigned as offset report information.

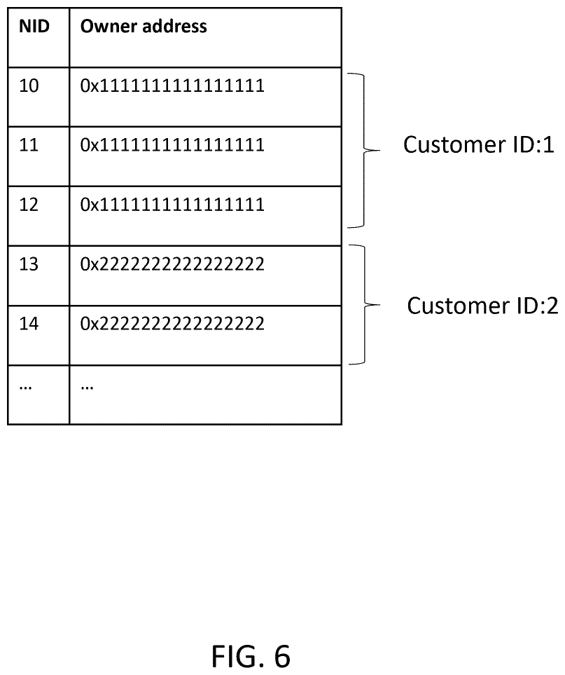

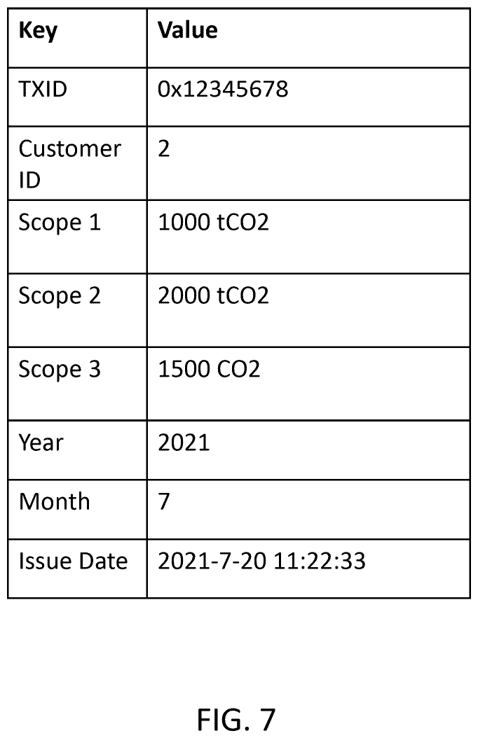

As shown in FIG. 6, blockchain addresses are associated with each NFTID on the blockchain network, and the NFTID and customer ID are managed at the management terminal 100. For example, information on greenhouse gas emissions for the business corresponding to customer ID “2” can be read by referring to the blockchain address for each NFTID, such as NFTID “13” and “14,” and the details of the emissions information can be read as shown in FIG. 7. FIG. 7 shows the information about the offset report corresponding to NFTID “14”, where the TXID is assigned to the offset report and the CO2 emissions by SCOPE, the subject year and month, and the date the report was issued are included in the offset report. In addition to the CO2 emissions for the target year and month in this example, the CO2 emissions for the most recent year, the CO2 emissions reduced, and the CO2 emissions offset can also be NFTed. By managing CO2 emissions through NFTs in this way, businesses can trade NFTed certificates while ensuring non-tampering and transaction reliability, and can also provide proof of emissions to third parties.

The above-mentioned embodiments are merely examples to facilitate understanding of the invention and are not intended to be construed as limiting the invention. It goes without saying that the invention may be changed and improved without departing from its purpose and that the invention includes its equivalents.

### DESCRIPTION OF REFERENCE NUMERALS

100 Management terminal
200 Business terminal

1. A method for managing greenhouse gas emissions, comprising:
determining information on energy consumption based on input information by a business terminal of a first business;
calculating the amount of greenhouse gas emissions based on the information on the amount of energy used; and
managing information on greenhouse gas emissions entered by a business terminal of a second business that is different from the first business as the greenhouse gas emissions of the first business.

2. The management method according to claim 1, wherein the second business is a business in the supply chain of the first business.

3. The management method according to claim 1, wherein the first business registers the second business as a guest account for managing greenhouse gas emissions.

4. The management method according to claim 1, wherein the information on greenhouse gas emissions entered by the business terminal of the second business is managed as information on SCOPE 2 or SCOPE 3 emissions of the first business's greenhouse gas emissions.
